(19) United States
(12) Patent Application Publication
(10) Pub. No.: US 2024/0224864 A9
(43) Pub. Date: Jul. 11, 2024

(54) ARTICLE ACQUISITION SYSTEM

(71) Applicant: N.CRAFT CORP., Aichi (JP)

(72) Inventor: Norimasa HAYASHI, Aichi (JP)

(73) Assignee: N.CRAFT CORP., Aichi (JP)

(21) Appl. No.: 18/547,385

(22) PCT Filed: Feb. 24, 2022
(86) PCT No.: PCT/JP2022/007761

§ 371 Date: Aug. 22, 2023

(30) Foreign Application Priority Data
Feb. 25, 2021 (JP) 2021-028082
Apr. 23, 2021 (JP) 2021-073544

(51) Int. Cl. A01D 46/30; B07C 5/10

(52) U.S. Cl. CPC A01D 46/30; B07C 5/10

(57) ABSTRACT

Provided is an article acquisition system including: an imaging unit configured to image an article; an arm capable of acquiring the article; a control unit configured to determine a shape of the article from image data captured by the imaging unit; and a display unit capable of selecting whether or not to acquire the article. In a case where determination is made to acquire the article imaged by the imaging unit, the control unit displays an arrangement position of the article on the display unit, and displays a screen to which an acquisition position of the article is input, and in a case where the acquisition position is input, the control unit moves the arm toward the arrangement position, and moves the arm in conformity to the acquisition position to acquire the article.

### TECHNICAL FIELD

The present disclosure relates to an article acquisition system.

### BACKGROUND ART

In the related art, an article acquisition system for acquiring articles such as crops is known (For example, refer to Patent Document 1). In a crop management system disclosed in Patent Document 1, crops are acquired by using a gantry type robot.

### CITATION LIST

### Patent Document

Patent Document 1: JP 2020-89345 A

### SUMMARY OF THE INVENTION

### Problem to be Solved by the Invention

For example, with regard to crops, sorting, harvesting or thinning, and the like of the crops are required to be performed as necessary in consideration of a growing situation. Determination as to whether or not to harvest or thin the crops has a high influence on a harvest yield, and thus it is difficult to uniformly determine the harvest or thinning by using a robot or the like. In addition, when harvesting or thinning the crops, it is also difficult to uniformly determine which position of the crops is to be gripped or to be cut off to acquire the crops.

An object of the present disclosure is to provide an article acquisition system capable of remotely performing article acquisition.

### Means for Solving Problem

An article acquisition system according to the present disclosure includes: an imaging unit configured to image an article; an arm capable of acquiring the article; a control unit configured to determine a shape of the article from image data captured by the imaging unit; and a display unit capable of selecting whether or not to acquire the article. In a case where determination is made to acquire the article imaged by the imaging unit, the control unit displays an arrangement position of the article on the display unit, and displays a screen to which an acquisition position of the article is input, and in a case where the acquisition position is input, the control unit moves the arm toward the arrangement position, and moves the arm in conformity to the acquisition position to acquire the article.

### Effect of the Invention

According to the present disclosure, it is possible to provide an article acquisition system capable of remotely performing article sorting.

### BRIEF DESCRIPTION OF DRAWINGS

FIG. 1 is a system diagram illustrating a crop management system according to a first embodiment of the present disclosure;

FIG. 2 is a side view illustrating an arrangement state of the crop management system according to the first embodiment of the present disclosure;

FIG. 3 is a top view illustrating the arrangement state of the crop management system according to the first embodiment of the present disclosure;

FIG. 4 is a flowchart illustrating a process carried out by a control device according to the first embodiment of the present disclosure;

FIG. 5 is a view illustrating an example of a strawberry in image processing performed by the control unit according to the first embodiment of the present disclosure;

FIG. 6 is a view illustrating an example of a cucumber in image processing performed by the control unit according to the first embodiment of the present disclosure;

FIG. 7 is a view illustrating an example of a screen displayed on a display unit according to the first embodiment of the present disclosure;

FIG. 8 is a view illustrating an example of a screen that is displayed on the display unit according to the first embodiment of the present disclosure in a case where thinning of a branch is performed;

FIG. 9 is a view illustrating an example of image data acquired by the control unit according to the first embodiment of the present disclosure;

FIG. 10 illustrates an article sorting system according to a second embodiment of the present disclosure;

FIG. 11 is a flowchart illustrating processes performed by a control device according to the second embodiment of the present disclosure;

FIG. 12 is a schematic view illustrating an example of a selection screen according to the second embodiment of the present disclosure;

FIG. 13 is a flowchart for controlling an acquisition position according to the first embodiment and the second embodiment of the present disclosure;

FIG. 14 is a view illustrating an example in which the acquisition position is displayed on the selection screen according to the second embodiment of the present disclosure; and

FIG. 15 is a view illustrating another example in which the acquisition position is displayed on the selection screen according to the second embodiment of the present disclosure.

### MODE(S) FOR CARRYING OUT THE INVENTION

### First Embodiment

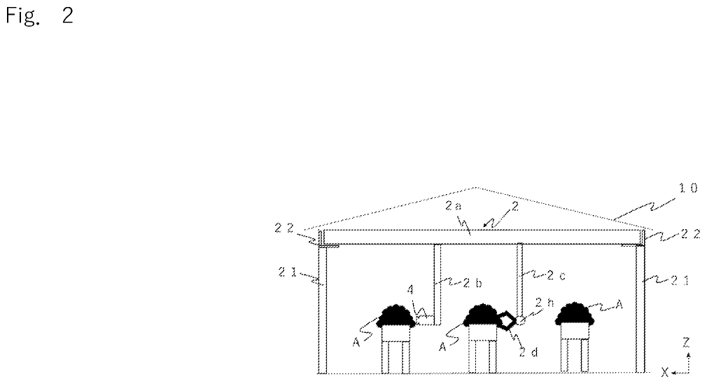

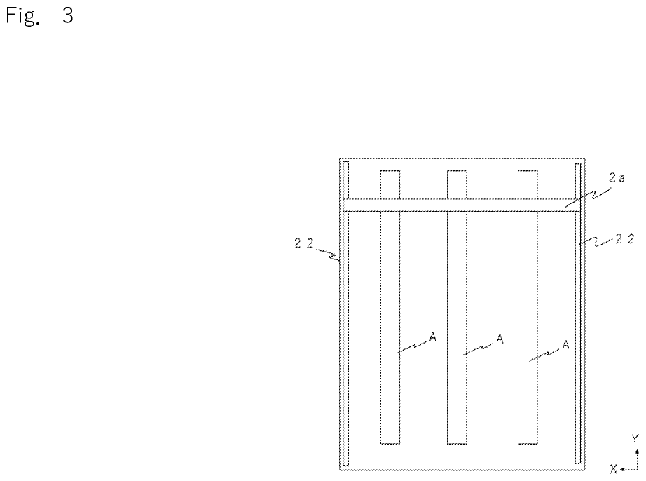

Hereinafter, a first embodiment of the present disclosure will be described with reference to the drawings. An article acquisition system according to the first embodiment is a crop management system. Note that, in this embodiment, a longitudinal direction of a vinyl house (an example of a house) 10 shown in FIG. 2 and FIG. 3 is described as a Y-direction, a lateral direction is described as an X-direction, and an upper and lower direction is described as a Z-direction in the specification and the drawings.

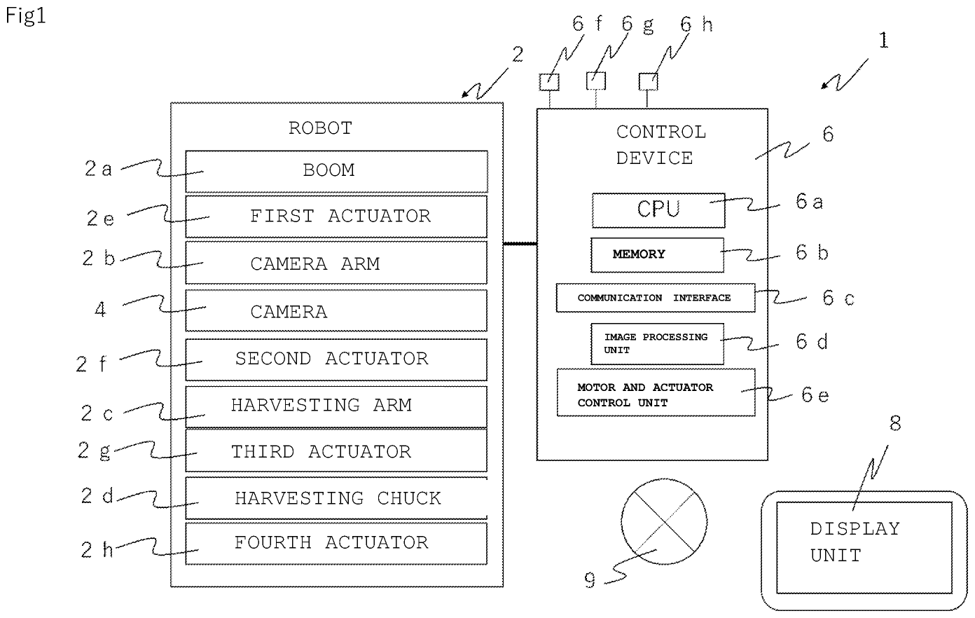

As illustrated in FIG. 1, the crop management system 1 of the present disclosure includes a robot 2, a camera (an example of an imaging unit) 4, a control device 6 (an example of a control unit), and a display unit 8.

The robot 2 includes, a boom 2a, a camera arm 2b, a harvesting arm 2c, and a harvesting chuck 2d provided at the tip end of the harvesting arm 2c. The boom 2a, the camera arm 2b, the harvesting arm 2c, and the harvesting chuck 2d are respectively provided with a first actuator 2e, a second actuator 2f, a third actuator 2g, and a fourth actuator 2h for movement.

As illustrated in FIG. 2 and FIG. 3, in this embodiment, the robot 2 is a gantry type that is installed in a vinyl house 10 for growing crops A. The gantry type robot 2 is installed over a ridge on which the crops A are planted.

The robot 2 includes a plurality of support columns 21 and at least two rails 22. The rails 22 extend in a longitudinal direction of the vinyl house 10 and are fixed to upper portions of the plurality of support columns 21. The boom 2a is stretched between the two rails 22. The boom 2a is driven by the first actuator 2e and freely moves on the rail 22 in the Y-direction.

The camera arm 2b is attached to the boom 2a. The camera arm 2b is driven by the second actuator 2f, freely moves with respect to the boom 2a in the X-direction and the Z-direction, and moves toward the crops A. The camera 4 is attached to the tip end of the camera arm 2b.

The harvesting arm 2c is attached to the boom 2a. The harvesting arm 2c is driven by the third actuator 2g shown in FIG. 1, freely moves with respect to the boom 2a in the X-direction and the Y-direction, and moves toward the crops A. The harvesting chuck 2d is attached to the tip end of the harvesting arm 2c. The harvesting chuck 2d can cut off and grip the crops A. In this embodiment, the harvesting chuck 2d is an end effector which rotates around, for example, the X-axis with respect to the harvesting arm 2c and in which a claw is opened and closed. A knife may be attached to the tip of the claw. The harvesting chuck 2d can access the crops A from both sides and upper side of the crops A. The harvesting chuck 2d is driven by the fourth actuator 2h, and opening and closing, and rotation of the claw are performed. The harvesting chuck 2d harvests the crops A by using the rotation, the claw, and the knife in this manner. Note that, the camera arm 2b and the harvesting arm 2c may be one arm that moves toward the crops A.

The camera 4 is a device that images the crops A. Examples of the camera 4 are a high-resolution camera that can image a color, a shape, and the like of the crops A in detail, and the like. The camera 4 is electrically connected to the control device 6, images the crops A, and transmits image data to the control device 6. The camera 4 can image both sides and an upper side of the crops A.

As illustrated in FIG. 1, the control device 6 is connected to the first actuator 2e to the fourth actuator 2h, the camera 4, and the like, and controls these devices. In addition, the control device 6 performs control for managing a growing state of the crops A by using at least the image data acquired by imaging the crops A with the camera 4. Actually, the control device 6 is constituted by a microcomputer including an arithmetic operation device (an example of an arithmetic operation unit) 6a, a memory (an example of a storage unit) 6b, a communication interface (an example of a communication unit) 6c, and input/output buffer, and the like. The control device 6 executes various kinds of control by software stored in the memory 6b. The control device 6 may be electrically connected to sensors and systems such as a soil sensor 6f that detects a pH value, a moisture, and a temperature of soil where the crops A are planted, a sunshine sensor 6g that detects the degree of sunshine, and a temperature management system 6h inside the vinyl house 10.

The control device 6 includes an image processing unit 6d and an actuator control unit 6e. The image processing unit 6d and the actuator control unit 6e are functional configurations realized by software stored in the memory 6b. The image processing unit 6d acquires sizes, colors, and shapes of the crops A from the image data acquired by the camera 4. The actuator control unit 6e controls respective actuators, and moves the boom 2a and respective arms to a predetermined position of the vinyl house 10.

The control device 6 records harvest prediction data in the memory 6b. More specifically, the control device 6 records the number of the crops A which can be harvested from data such as the number of seeds or seedlings of the crops A planted, the number of sunshine days, soil conditions, and the number of growing days. The control device 6 compares the information and the number of sunshine days up to the current time, a variation in the soil conditions with each other to create harvest prediction data that increases or decreases the predicted number of harvest, and records the data.

The display unit 8 displays a screen capable of selecting whether or not to set the crops A as a harvest or thinning target. In addition, in a case where thinning is selected, the display unit 8 displays a screen for asking a user to determine whether or not to thin out a branch. In a case where the user performs thinning of a branch, the display unit 8 displays the branch on the screen for determining a line for cutting off the branch. That is, thinning of the crops A includes selection and cutting-off of not only harvest articles such as fruit but also branches around the harvest articles and the like. The display unit 8 may display a screen necessary for a management user who operates the crop management system 1. For example, the display unit 8 is a touch-screen-type liquid crystal panel of a smartphone, a tablet, or the like, or a liquid crystal screen of a desktop computer or the like. The display unit 8 is electrically connected to the control device 6 in a wired manner or by mobile communication. In this embodiment, the display unit 8 is wirelessly connected to the control device 6 by the Internet 9.

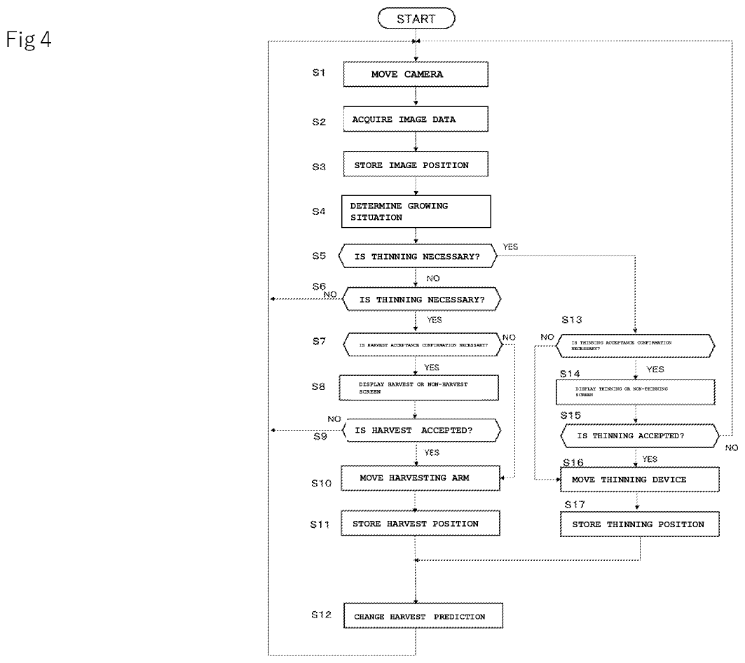

Next, controls steps executed by the control device 6 will be described with reference to a flowchart in FIG. 4.

As illustrated in FIG. 4, the control device 6 moves the camera arm 2b to image the crops A by the camera 4 (step S1). The control device 6 acquires captured image data (step S2). The control device 6 continuously monitors the size, the color, and the shape of the crops A by periodically acquiring images of all of the crops A inside the vinyl house 10. When obtaining the image data, the control device 6 records a position where the image data is acquired in the memory 6b in combination with the image data (step S3).

The control device 6 subjects the image data to image processing and determines a growing situation (step S4). More specifically, the control device 6 subjects the captured image data of the crops A to image processing, compares the image data with reference data that is ideal data of the size, the color, and the shape of the crops A in correspondence with the number of growing days, and makes a determination in three stages, for example, in the order of “good”, “observation is required”, and “poor” in the growing situation. The determination may be made in a plurality of stages without limitation to the three stages. When the growing state is determined, the control device 6 determines whether or not thinning is necessary (step S5).

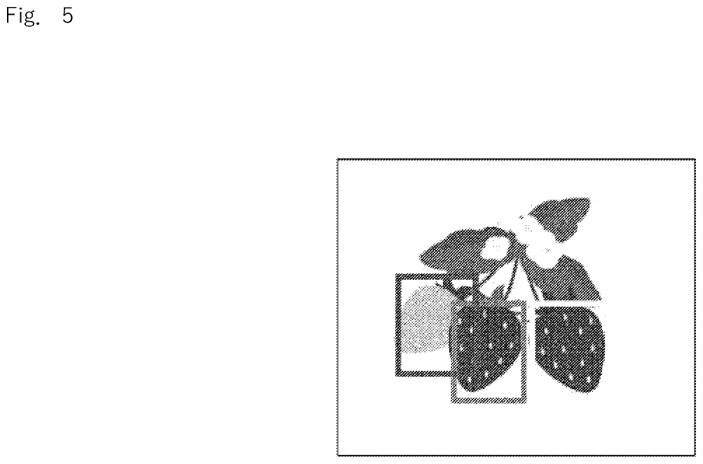

Specifically, as illustrated in FIG. 5, for example, in a case where the crops A are strawberries, the control device 6 compares reference data that is recorded in the harvest prediction data and determines a size, a color, and a shape of the strawberries in correspondence with the number of growing days, and strawberries of image data. The control device 6 performs comparison with the reference data, and determines whether or not the strawberries of the image data match the reference data in a predetermined ratio or more (in this embodiment, 90% or more). For example, it is assumed that a color of a strawberry on the leftmost side in FIG. 5 is slightly blue, and a ratio of the blue color matches a red color in the reference data only by approximately 70%. In this case, the control device 6 determines that a growing state of the strawberry on the leftmost side in FIG. 5 is “poor”.

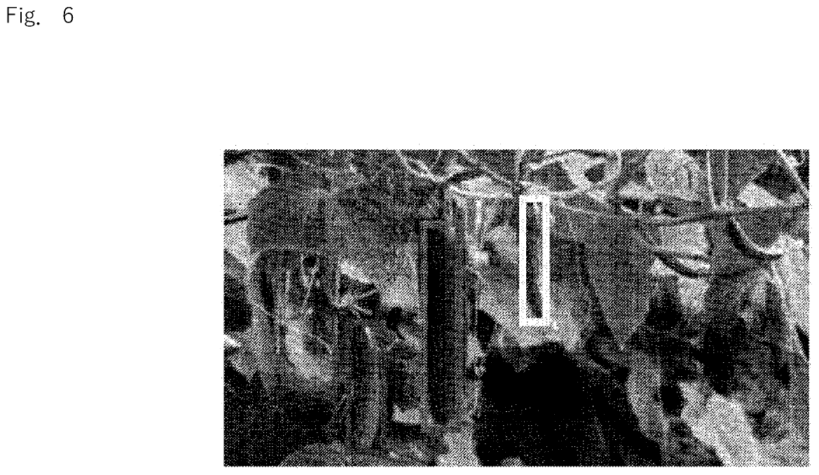

On the other hand, it is assumed that a color of a strawberry on the center in FIG. 5 approximately matches the reference data, but the size matches the reference data only by approximately 80%. In this case, the control device 6 determines a growing state of the central strawberry in FIG. 5 as “observation is required”. Crops A illustrated in FIG. 6 are cucumbers. It is assumed that a shape of a right cucumber in FIG. 6 matches the reference data only by approximately 80%. In this case, the control device 6 determines the right cucumber in FIG. 6 as “observation is required”.

In a case where it is determined that thinning is necessary (YES in step S5), the process proceeds to step S13 by the control device 6. In this embodiment, in step S5, in a case where the control device 6 determines the growing state as “observation is required” or “poor”, the control device 6 determines that thinning is necessary. On the other hand, in a case where it is determined that thinning is not necessary (NO in step S5), the process proceeds to step S6 by the control device 6. In this embodiment, in a case where the growing state of the crops A from which an image is acquired is “good”, the control device 6 determines that thinning is not necessary.

The control device 6 determines whether or not harvest is necessary (step S6). In a case where all items of the size, the color, and the shape match the reference data by 90% or more, or in a case where the number of growing days reaches a predetermined number of days, the control device 6 determines that harvest is necessary.

On the other hand, even in a case where all items of the size, the color, and the shape match the reference data by 90% or more, further maturing may be preferable. The determination is preferably made by a management user of the crop management system 1. Therefore, in this case, it is preferable that the control device 6 determines that the management user is required to make a determination as to whether or not harvest is necessary. Here, the control device 6 determines whether or not harvest acceptance confirmation is necessary (step S7). In this embodiment, for example, with respect to crops A of which all items of the size, the color, and the shape match the reference data by 90%, but a matching rate of at least one of the size, the color, and the shape is from 90% to 95%, the control device 6 determines that the harvest acceptance confirmation is necessary.

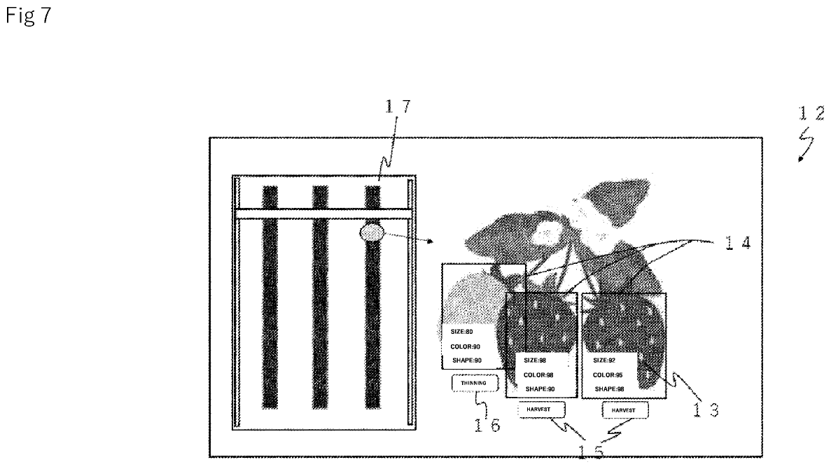

In a case where it is determined that the harvest acceptance confirmation is necessary (YES in step S7), the control device 6 displays a harvest or non-harvest screen 12 on the display unit 8 (step S8). More specifically, the control device 6 generates the harvest or non-harvest screen 12 and transmits the harvest or non-harvest screen 12 to the display unit 8 through the communication interface 6c to be displayed. FIG. 7 is an example of the harvest or non-harvest screen 12. For example, the harvest or non-harvest screen 12 includes image data information 13 of the crops A which is captured by the camera 4, a frame 14 that displays reference data information, a harvest acceptance button 15, a thinning acceptance button 16, and image data acquisition position displaying information 17. The management user of the crop management system 1 can select harvest or non-harvest by touching or clicking the button 15 or the button 16 on the harvest or non-harvest screen 12 displayed on the display unit 8.

The control device 6 determines whether or not harvest is accepted by the management user (step S9). In a case where it is determined that harvest is accepted by the management user (YES in step S9), the control device 6 moves the harvesting arm 2c to a position where an image of the crops A is acquired, and harvests the crops A (step S10). The control device 6 records the harvested position (step S11), reduces the number of harvests from the harvest prediction data and excludes the harvested crops A from a monitoring target (step S12), and returns the process to step S1.

In a case where the management user determines that harvest is not necessary (NO in step S6), and harvest is not accepted (NO in step S9), the control device 6 returns the process to step S1. In a case where it is determined that harvest acceptance confirmation is not necessary (NO in step S7), the control device 6 allows the process to proceed to step S10, and moves the harvesting arm 2c.

Next, description will be given of a case where it is determined that thinning is necessary in step S5. In a case where it is determined that thinning is necessary (YES in step S5), the control device 6 determines whether or not thinning acceptance confirmation is necessary (step S13).

In a case where the crops A are uniformly thinned through determination made by the control device 6, the amount of the harvested crops A decreases, and the productivity of the crops A deteriorates. Here, in a case where a determination by the management user is required for any of the crops A, the control device 6 determines that thinning acceptance confirmation is required. In this embodiment, for example, the thinning acceptance confirmation is required for the crops A determined as “observation is required” in the growing situation determination in step S4.

In a case where it is determined that the thinning acceptance confirmation is required (YES in step S13), the control device 6 displays a thinning or non-thinning screen on the display unit 8 (step S14). More specifically, the control device 6 generates a thinning or non-thinning screen, and transmits the thinning or non-thinning screen to the display unit 8 through the communication interface 6c to be displayed. In this embodiment, the thinning or non-thinning screen is the same as the harvest or non-harvest screen 12. However, the thinning or non-thinning screen may be displayed on the screen different from the harvest or non-harvest screen 12. A user of the crop management system 1 can select thinning or non-thinning by touching or clicking the button 16.

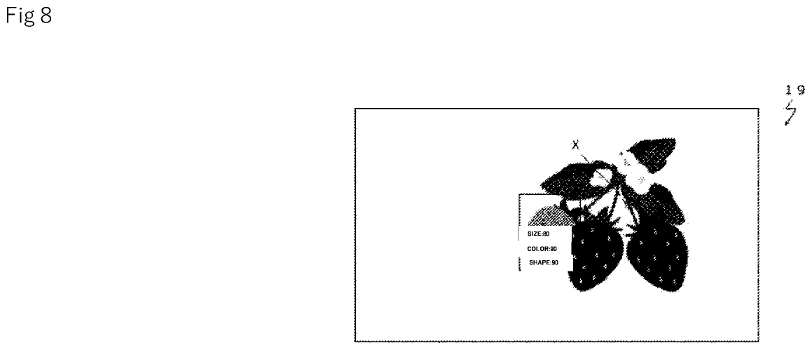

In a case where thinning is accepted by the management user, the control device 6 may display a screen for obtaining a determination as to whether or not to thin branches from the management user. In this embodiment, the control device 6 obtains the determination as to whether or not to thin branches by displaying a button 16 for designating a branch thinning position on the harvest or non-harvest screen 12. When the button 16 is touched or clicked by the management user, the control device 6 displays a branch thinning position designation screen 19. On the screen 19, the management user designates a branch thinning position. For example, the management user makes a designation by touching and tracing a position (acquisition position) of a branch to be thinned (refer to an arrow from X to Y in FIG. 8). The control device 6 converts a line traced by the management user into coordinates through image processing. Acquisition position control will be described collectively with a second embodiment.

The control device 6 determines whether or not thinning is accepted (step S15). In a case where the thinning is accepted (YES in step S15), the control device 6 moves the harvesting arm 2c to a position where an image of the crops A is acquired, and thins the crops A (step S15). In a case of thinning a branch, the control device 6 moves the harvesting arm 2c to the branch, and cuts out the branch. The control device 6 records a thinning position (step S16), reduces the number of harvests from the harvest prediction data, and returns the process to step S1.

In a case where thinning is not accepted (NO in step S15), the control device 6 returns the process to step S1. In a case where it is determined that thinning acceptance confirmation is not necessary (No in step S13), the control device 6 allows the process to proceed to step S16, and moves the harvesting arm 2c.

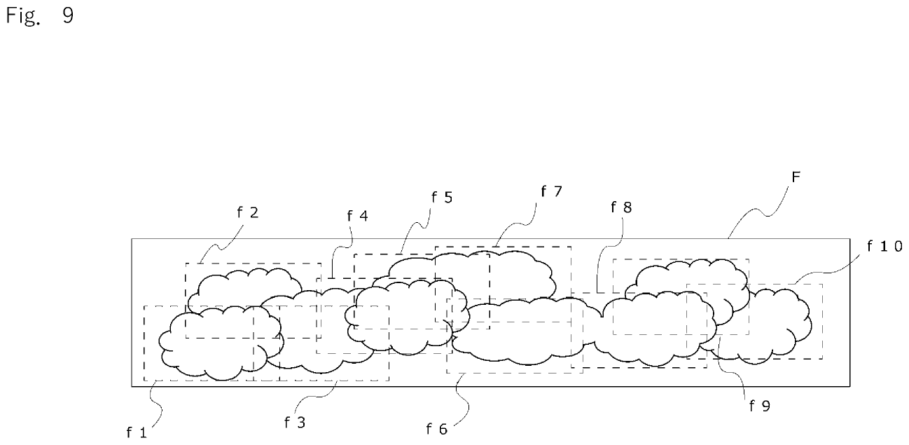

In this embodiment, the control device 6 subjects the image of the crops A which is captured by the camera 4 to image processing for every captured image, and generates the harvest or non-harvest screen 12, but the present disclosure is not limited thereto. That is, as illustrated in FIG. 9, the control device 6 may capture image data f1 to f10 by the camera 4 while moving the camera arm 2b. Furthermore, the control device 6 may synthesize the image data f1 to f10 in advance, and may acquire the image data as one piece of image data F. The control device 6 may acquire one piece of image data F with respect to one ridge where the crops A are planted, or may one or a plurality of pieces of image data F in any section without limitation thereto.

Furthermore, the control device 6 displays the generated harvest or non-harvest screen 12 on the display unit 8 immediately, but the present disclosure is not limited thereto. That is, after imaging the crops A with the camera 4 at predetermined time, and generating the harvest or non-harvest screen 12, the control device 6 may display the harvest or non-harvest screen 12 on the display unit 8 after any time. For example, the control device 6 acquires the image data F in advance during a time period advantageous for imaging conditions with the camera 4, and generates the harvest or non-harvest screen 12. Then, after passage of any time, the management user may select harvest or non-harvest while viewing the harvest or non-harvest screen 12 displayed on the display unit 8. That is, the management user may cause the display unit 8 to display the harvest or non-harvest screen 12 generated in advance at any time to select harvest or non-harvest.

According to this, the management user can select harvest or non-harvest on the basis of one piece of the image data F created in advance without an influence on an imaging interval or imaging time in the camera 4. Therefore, the management user can select harvest or non-harvest of the crops A at any point of time. As a result, the crop management system 1 can remotely perform work at any point of time or any time span for the management user.

### Second Embodiment

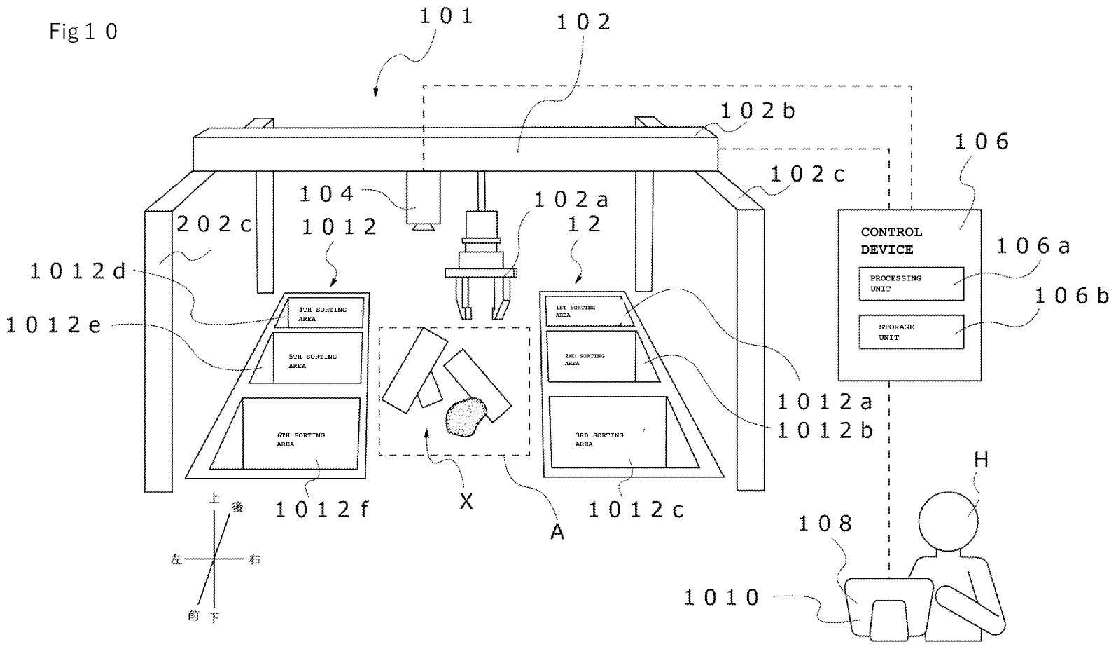

As illustrated in FIG. 10, an article acquisition system according to a second embodiment of the present disclosure is an article sorting system 101. The article sorting system 101 includes a grip device 102, a camera 104, a control device 106, a display 108, an input device 1010, and a sorting area 1012. In this embodiment, the article sorting system 101 is a waste sorting system that sorts a plurality of wastes X (an example of articles) in which various materials such as woods, metals, rubbers, glass, and resins, and wastes having various shapes, which are conveyed into a waste disposal site, are mixed in. When being conveyed into the waste disposal site, the wastes X are temporarily stacked in a state in which a material quality or material Y (an example of the type of articles) are mixed in regardless of types of the wastes X, and are subjected to rough sorting (an example of a sorting process). In the rough sorting, the article sorting system 101 sorts a plurality of wastes X for every material quality or material Y determined in advance.

The grip device 102 includes an actuator (not illustrated) and an arm (an example of a grip unit) 102a. In this embodiment, the grip device 102 is a gantry type robot. In the gantry type robot, a boom 102b moves on a pair of rails 102c in a front and rear direction by an actuator, and an arm 2a which is attached to the boom 102b moves a right and left direction and an upper and lower direction. Note that, the rails 102c may be attached to a structure member of a building in the waste disposal site into which the plurality of wastes X are conveyed. A conveying device is electrically connected to a control device 106 to be described later, the actuator is controlled by the control device 106, and the plurality of wastes X are gripped by the arm 102a to be moved to a predetermined position. Note that, the grip device 102 may be, for example, a device such as a robot arm without limitation to the gantry type robot. In addition, a plurality of the grip device 102 may be provided.

The camera 104 images the wastes X. In this embodiment, the camera 104 is attached to the boom 102b of the grip device 102. In addition, the camera 104 may be attached to a ceiling, a beam, or the like of a factory where a sorting process is performed. However, the camera 104 may be attached to a location other than the boom 102b of the grip device 102. The camera 104 images the wastes X included in an imaging area A. The camera 104 moves in correspondence with movement of the boom 102b, and may repeat capturing of still images at regular intervals. The camera 104 is electrically connected to the control device 106 to be described later, and transmits image data (an example of a video) D of captured moving images or still images to the control device 106.

The control device 106 is provided to control the article sorting system 101. The control device 106 is electrically connected to the camera 104, the display 108 to be described later, and the input device 1010, and can establish communication with the respective devices. The control device 106 includes a processing unit 106a and a storage unit 106b. Actually, the control device 106 is constituted by a microcomputer including a processing unit 106a including a central processing unit (CPU), a graphics processing unit (GPU), or the like, a storage unit 106b including a hard disk drive (HDD), a random access memory (RAM), or the like, and an input/output buffer, and the like. The processing unit 106a generates a selection screen S to be described later on the basis of a video captured by the camera 104. The storage unit 106b stores combination data (an example of a combination) Z of the wastes X and the material quality or material Y of the wastes X.

The display 108 displays the selection screen S. In this embodiment, the display 108 is a portable communication terminal configured integrally with the input device 1010 to be described later. In addition, the display 108 may be a smartphone or a tablet configured integrally with the input device 1010. However, the display 108 may be configured separately from the input device 1010. In addition, the display 108 may be a tower-type personal computer that is used in combination with the input device 1010.

The input device 1010 inputs combination data Z of the wastes X and the material quality or material Y corresponding to the wastes X. The input device 1010 may be connected to the control device 106 to establish communication in a wired manner or in a wireless manner through a line such as the Internet and a virtual private network (VPN). In this embodiment, the input device 1010 is an input terminal that is provided in combination with the display 108, and has keys corresponding to the material quality or material Y of the wastes X. In addition, the input device 1010 may be configured as a physical key configured integrally with the display 8. However, the input device 1010 may be configured as an input icon that is displayed on the display 108 in combination with the selection screen S. The input device 1010 is arranged in a room or a building different from the location where the camera 104, the grip device 102, the sorting area 1012 are arranged, and is operated by an operator H. Accordingly, rough sorting by the article sorting system 101 can be carried out through the input device 1010 without placing the operator H in the vicinity of the grip device 102 where the wastes X are stacked. As a result, according to the article sorting system 101, the operator H can carry out rough sorting without being restricted by working environments such as the smell of the wastes X and dusts generated due to sorting.

The sorting area 1012 includes a plurality of sorting areas 1012a to 1012f. In this embodiment, the sorting area 1012 includes six sorting areas including a first sorting area 1012a where wastes X of which a material quality or material Y is a wood are sorted, a second sorting area 1012b where wastes X of which a material quality or material Y is a metal are sorted, a third sorting area 1012c where wastes X of which a material quality or material Y is a resin are sorted, a fourth sorting area 1012d where wastes X of which a material quality or material Y is a rubber are sorted, a fifth sorting area 1012e where wastes X of which a material quality or material Y is glass are sorted, and a sixth sorting area 1012f where wastes X of which a material quality or material Y is the other materials are sorted. However, a plurality of the sorting areas 1012 may be provided, and for example, sorting areas different in accordance with not only the material quality or material but also the size or the shape of the wastes may be formed. In addition, in this embodiment, the first sorting area 1012a to the third sorting area 1012c are provided on the left side of a position into which the wastes X are conveyed, and the fourth sorting area 1012d to the sixth sorting area 1012f are provided on the left side opposite to the right side with the wastes X interposed therebetween. When arranging the sorting areas 1012 in this manner, the grip device 102 can efficiently convey the wastes X. However, the sorting areas 1012 may be provided within a range where the grip device 102 can be conveyed. The respective sorting areas 1012a to 1012f are provided a belt conveyor (not illustrated), and the wastes X moved by the grip device 102 are loaded on the belt conveyor and are transmitted to a detail sorting process as a subsequent process.

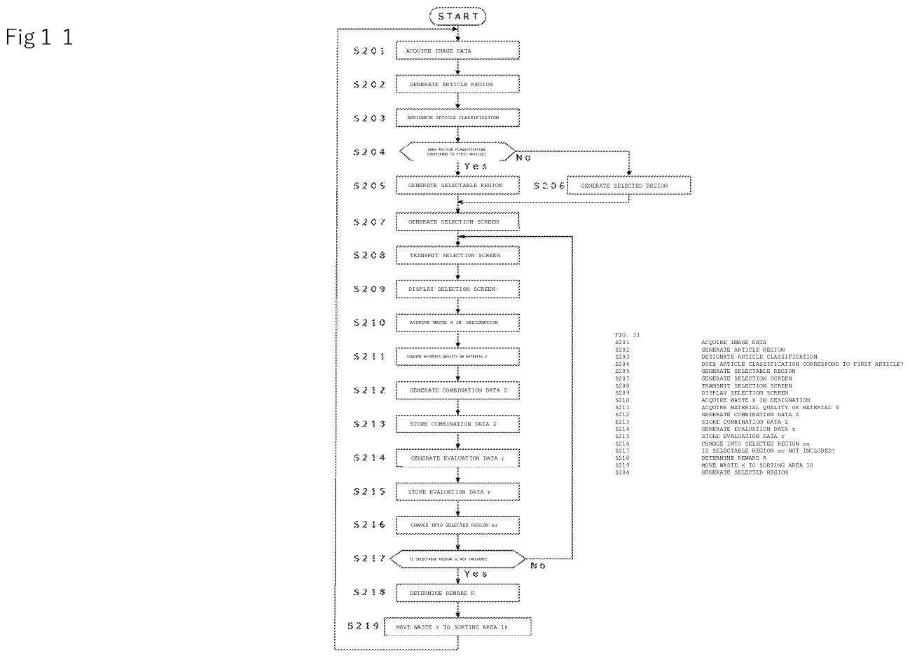

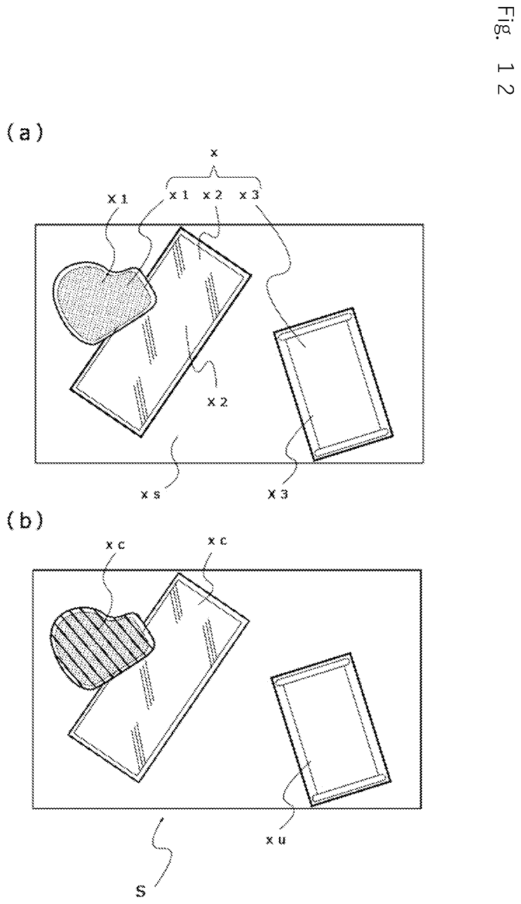

Next, a control step carried out by the control device 106 will be described with reference to a flowchart in FIG. 11 and FIG. 12. When a start button (not illustrated) is pressed, the control device 106 starts the control step.

The control device 106 acquires the image data D captured by the camera 104 (step S201). The processing unit 106a of the control device 106 generates an article region x on the basis of the acquired image data D (step S102). The article region x is a region obtained by partitioning the image data D for every waste X included in the image data D. In a case where one piece of waste X is included in the image data D, the image data D is partitioned into an article region x1 and a region xs excluding the article region. As illustrated in FIG. 12(a), in a case where three wastes X1 to X3 are included in the image data D, the image data D is partitioned into three article regions x1 to x3, and a region xs excluding the article regions.

The processing unit 106a of the control device 106 designates an article classification C of the article region x (step S203). The storage unit 106b of the control device 106 stores the combination data Z that is a combination of the waste X and the material quality or material Y of the waste X in advance. The article classification C includes a first article C1 and a second article C2. The first article C1 is another article excluding the second article C2. On the basis of the existing combination data Z stored in the storage unit 106b of the control device 106 in advance, the article classification C of the waste X of which the material quality or material Y cannot be specified is designated to the first article C1. On the basis of the existing combination data Z stored in the storage unit 106b of the control device 106 in advance, the article classification C of the waste X of which the material quality or material Y can be specified is designated to the second article C2. The processing unit 106a designates either the first article C1 or the second article C2 to each article region x as the article classification C. In this embodiment, with regard to the waste X3 among the wastes X1 to X3 included in the image data D, since the material quality or material Y can be specified as a metal on the basis of the existing combination data Z stored in the storage unit 106b of the control device 106, as the article classification C of the waste X3, the second article C2 is designated. In addition, since the material quality or material Y cannot be specified on the basis of the existing combination data Z, as the article classification C of the wastes X1 and X2, the first article C1 is designated.

The processing unit 106a of the control device 106 determines whether or not the article classification C of the article regions x1 to x3 corresponds to the first article C1 (step S204). In a case where the article region x corresponds to the first article C1 (Yes in step S204), the processing unit 106a of the control device 106 generates an article selection portion xc that is a screen display corresponding to the first article C1 (step S205). The processing unit 106a of the control device 106 generates the article selection portion xc by performing image processing on the article regions x1 and x2 corresponding to the wastes X1 and X2 to which the first article C1 is designated as the article classification C in step S203. In this embodiment, with respect to the article regions x1 and x2 generated in step S202, the processing unit 106a of the control device 106 generates an image display filled with oblique line patterns as an image display different from that of the article region x3 and the region xs excluding the article region. That is, in this embodiment, the article selection portion xc is an image display generated as filling with the oblique line pattern in a shape corresponding to the article region x of the waste X of which the article classification C is the first article C1. The article selection portion xc may be distinguished from the article region x of the waste X of which the article classification C is the first article C1 and the other article regions x, and may be an image display such as a thick line showing a boundary of the article region x and a translucent filled region in addition to the filling with the oblique line patterns.

On the other hand, in the opposite case (No in step S204), the processing unit 106a generates a selected region xu with respect to the article region x (step S206). In this embodiment, with respect to the article region x3 generated in step S202, the processing unit 106a of the control device 106 generates the selected region xu as a thick line image display showing a boundary of the article region x3. An operator H to be described later may recognize that the selected region xu is not the article selection portion xc, and the selected region xu may be an image display filled with a pattern different from that of the article selection portion xc. In addition, with respect to the selected region xu, an image display corresponding to the selected region xu may not be generated.

The processing unit 106a of the control device 106 generates a selection screen S (step S207). As illustrated in FIG. 12(b), the selection screen S is screen data synthesized by overlapping the image display of the article selection portion xc generated in step S205 on the image data D. That is, with regard to the selection screen S, only the article region x corresponding to the waste X determined as the first article C1 in step S204 in the article region x corresponding to the waste X included in the image data D is synthesized to the image data D as the article selection portion xc. As illustrated in FIG. 12(b), the processing unit 106a may further overlap the selected region xu generated in step S206 to the image data D. In this embodiment, image information obtained by synthesizing the article selection portion xc generated with respect to the article regions x1 and x2 corresponding to the wastes X1 and X2 of which the article classification C is the first article C1, and the image data D is generated as the selection screen S. That is, the selection screen S is displayed in a manner in which the wastes X1 and X2 of which the article classification C is the first article C1 are clearly distinguished from the other waste X3 of which the article classification C is the second article C2.

The control device 106 transmits the selection screen S to the display 8 (step S208). The control device 106 causes the display 108 to display the selection screen S (step S209). Here, with respect to the waste X on which the article selection portion xc is displayed, the operator H estimates the material quality or material Y of the waste X, selects the article selection portion xc and the material quality or material Y of the waste X corresponding to the article selection portion xc, and inputs the article selection portion xc and the material quality or material Y to the input device 1010 while viewing the selection screen S displayed on the display 108. The processing unit 106a of the control device 106 acquires the waste X corresponding to the article selection portion xc input by the input device 1010 (step S210). The processing unit 106a of the control device 106 acquires the material quality or material Y input by the input device 1010 (step S211). Furthermore, the processing unit 106a of the control device 106 generates the combination data Z by combining the waste X acquired in step S209 and the material quality or material Y acquired in step S210 (step S212). The storage unit 106b of the control device 106 stores the combination data Z (step S213).

The processing unit 106a of the control device 106 generates evaluation data r corresponding to the combination data Z generated in step S212 (step S214). In this embodiment, the processing unit 106a of the control device 106 selects and generates one among predetermined evaluation levels set in advance as the evaluation data r.

The processing unit 106a may generate the evaluation data r on the basis of time required until the combination data Z is generated in step S212 after the selection screen S is displayed on the display 108 in step S209. In a case where the required time until the combination data Z is generated is short, that is, in a case where the operator H completes the input of the waste X and the material quality or material Y in a short time, the processing unit 106a may generate the evaluation data r by selecting the highest evaluation level. In this manner, the processing unit 106a may generate the evaluation data r by selecting an evaluation level in correspondence with the required time until the combination data Z is generated.

In addition, the processing unit 106a of the control device 106 may generate the evaluation data r on the basis of a difference between the combination data Z stored in the storage unit 106b of the control device 106 in advance and the combination data Z generated in step S212. Specifically, in a case where it is determined that the combination data Z of the waste X and the material quality or material Y of the waste X input to the input device 1010 by the operator H approximates the combination data Z stored in the storage unit 106b of the control device 106 in advance in a predetermined range through comparison, that is, it is determined that the material quality or material Y of the waste X is appropriately selected and input, the processing unit 106a of the control device 106 may generate the evaluation data r by selecting the highest evaluation level. In this manner, the processing unit 106a may generate the evaluation data r by selecting an evaluation level in correspondence with the accuracy of the combination data Z generated in step S212.

In addition, the evaluation data r may be changed in correspondence with various conditions such as a time zone when the waste X and the material quality or material Y of the waste X are input through the input device 1010 and identification information of the operator H which is stored in the storage unit 106b of the control device 106 in advance. Specifically, in a case where input by the input device 1010 is performed in a time zone set in advance or working time, the processing unit 106a may generate the evaluation data r by selecting the highest evaluation level. In addition, the processing unit 106a may generate the evaluation data r by selecting an evaluation level in correspondence with the degree of skill of the operator H.

The storage unit 106b of the control device 106 stores the evaluation data r generated in step S213 in association with the combination data Z generated in step S212 (step S215). According to this, the evaluation data r associated with the combination data Z can be accumulated in the storage unit 106b. As a result, the article sorting system 101 can improve an execution speed and accuracy of the rough sorting on the basis of the combination data Z and the evaluation data r stored in the storage unit 106b.

The processing unit 106a of the control device 106 changes the article selection portion xc corresponding to the waste X acquired in step S210 into the selected region xu (step S216). According to this, it is possible to prevent the material quality or material Y from being redundantly and repeatedly input through the input device 1010 with respect to the same waste X. As a result, the article sorting system 101 can improve the execution speed of the rough sorting.

The processing unit 106a of the control device 106 determines whether or not the article selection portion xc is to be included in the selection screen S (step S217). In a case where it is determined that the article selection portion xc is not included in the selection screen S (Yes in step S217), the processing unit 106a of the control device 106 determines a reward R on the basis of the evaluation data r stored in the storage unit 106b (step S218). In this embodiment, the processing unit 106a of the control device 106 calculates and determines the reward R as a monetary reward given to the operator H who inputs the waste X and the material quality or material Y of the waste X through the input device 1010. The reward R is determined in accordance with the evaluation data r generated in step S214 and the number of times of input of the waste X and the material quality or material Y that is performed by the operator H with the input device 1010. Specifically, the higher the evaluation level of the evaluation data r and the larger the number of times of input, the further the reward R given to the operator H increases. According to this, it is possible to give appropriate reward R to the operator H in correspondence with the accuracy of the combination data Z of the waste X and the material quality or material Y input to the input device 1010, and the number of times of input. According to this, the operator H can be more motivated to perform input work on the input device 1010. As a result, it is possible to widely secure personnel engaged in the rough sorting of the waste X.

On the other hand, in the opposite case (No in S217), the processing unit 106a of the control device 106 returns the process to before step S208.

The processing unit 106a of the control device 106 controls the grip device 102 to move the waste X to the sorting area 1012, and returns the process to before step S201 (step S219). In this embodiment, the processing unit 106a of the control device 106 generates a movement route to the sorting area 1012 corresponding to the material quality or material Y of the waste X on the basis of the image data D and the combination data Z generated in step S211, and controls the grip device 102 to move the waste X to the predetermined sorting area 1012.

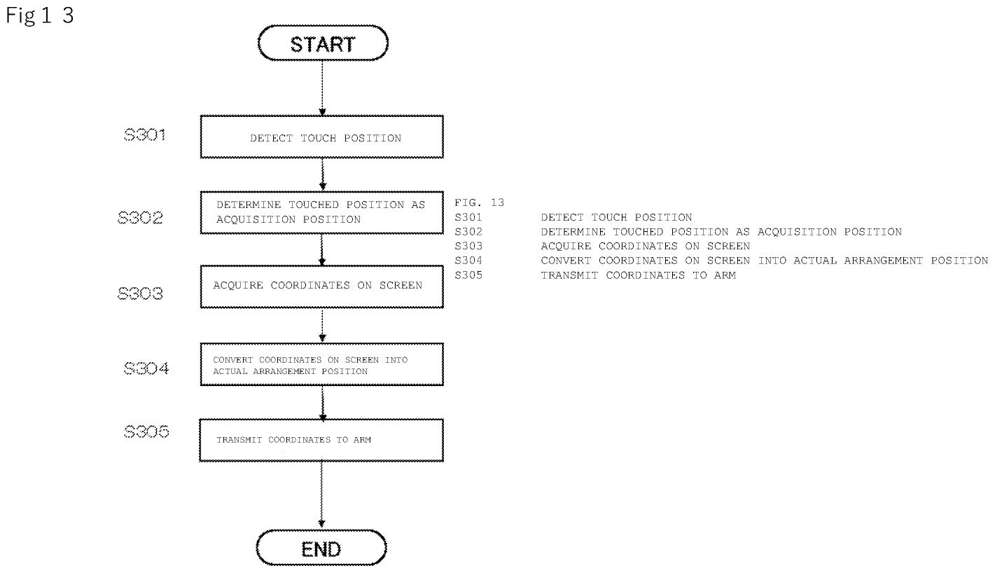

Next, description will be given of the acquisition position in the first embodiment and a display method of an acquisition position in the second embodiment with reference to FIG. 13 to FIG. 15. In the following description, description will be given of a case where the grip device 102 grips and moves the waste X in the second embodiment.

The control device 106 acquires a position of the display 108 which is touched by the operator H (step S301). Specifically, the operator H views the selection screen S displayed on the display 108 and selects the waste X1 to be gripped by the grip device 102 through a touching operation. The control device 106 acquires a touch position on the display 108.

The control device 106 determines the touch position acquired in step S301 as an acquisition position (step S302). Furthermore, the control device 106 acquires coordinates on a screen in the selection screen S on the basis of the acquisition position determined in step S302 (step S303).

The control device 106 converts the coordinates on a screen which are acquired in step S303 into actual arrangement position (step S304). That is, the control device 106 converts the acquisition position on the selection screen S into coordinates in an actual working environment of the grip device 102, and sets the coordinates as the arrangement position.

Finally, the control device 106 transmits the arrangement position as the coordinates acquired through conversion in step S304 to the arm 102a of the grip device 102 (step S305).

This embodiment is also applicable to the control device 6 in the first embodiment without limitation to the above-described configuration. That is, the control device 6 may acquire a position where management user causes the harvesting arm 2c to thin a branch through a touch operation while viewing the harvest or non-harvest screen 12 displayed on the display unit 8 as the acquisition position, and may control the harvesting arm 2c (for example, refer to FIG. 8).

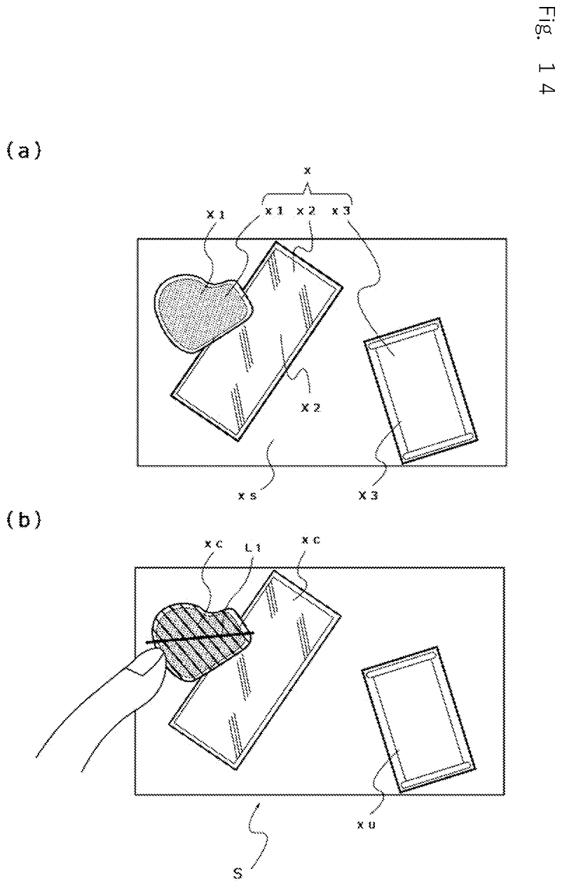

FIG. 14(a) is a schematic view illustrating a state in which a plurality of selectable articles X1 to X3 are displayed on the selection screen S of the display 108 that is operated by the operator H. FIG. 14(b) is a schematic view illustrating a state in which the article X1 is selected among the plurality of articles X1 to X3. The operator H selects the article X1 by tracing the article X1 among the plurality of articles X1 to X3 displayed on the selection screen S. When the operator H touches the display 108 while performing tracing, as illustrated in FIG. 14(b), the control device 106 approximates a position traced with a finger to a straight line and superimposes and displays a straight line L1 on an image of the article X1 selected by the touch operation. The control device 6 determines an acquisition position where the grip device 102 acquires the article X1 on the basis of the position of the straight line L1 and a direction thereof.

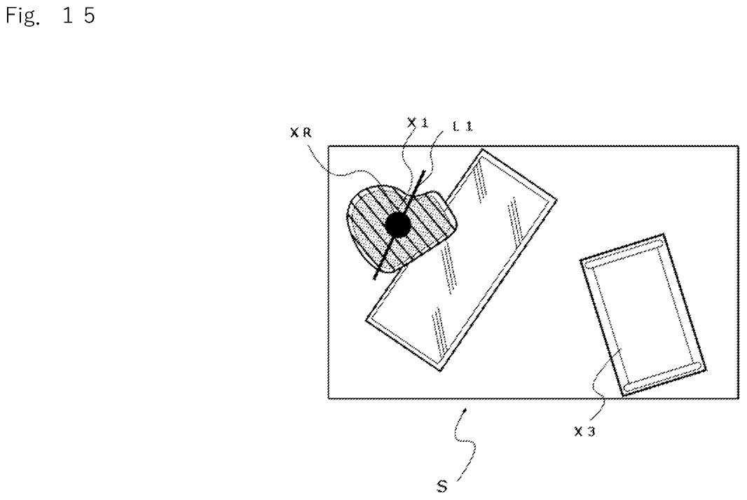

In addition, as illustrated in FIG. 15, the control device 6 may display a rotating cursor XR superimposed and displayed on the selected article X1. The operator H can change an angle of the straight line L1 by rotating the cursor XR on the display 108 by any angle. According to this, the operator H can change a direction of the straight line L1 superimposed and displayed on the selected article X1 by tracing the display 108 by any angle without canceling the selected state. As a result, the control device 106 can acquire positional information for griping the selected article X1 with the grip device 102 through a simple operation by the operator H.

### Other Embodiments

Hereinbefore, the embodiments of the present disclosure have been described, but the present disclosure is not limited to the above-described embodiment, and various modifications can be made within a range not departing from the gist of the invention.
(a) In the above-described first embodiment, the gantry type robot 2 has been described as an example, but the invention is not limited thereto. The robot 2 may be self-travelling gantry type robot without rails, or a robot with a self-travelling robot arm. In any case, the robot 2 may be a robot capable of imaging and harvesting the crops A.
(b) In the above-described second embodiment, the article sorting system 1 of sorting the wastes X has been described as an example, but the present disclosure is not limited thereto. The article sorting system 1 may be a system for sorting articles to be conveyed, and may also be a system that sorts and conveys a plurality of stacked articles (for example, crops and the like) different in a shape or a color.
(c) In the above-described second embodiment, the processing unit 106a of the control device 106 selects and generates one among predetermined evaluation levels set in advance as the evaluation data r, but the present disclosure is not limited thereto. As the evaluation data r, various aspects such as numerical values and variables for determining the reward R can be selected.
(d) In the above-described second embodiment, the reward R is calculated and determined as a monetary reward given to the operator H, but the present disclosure is not limited thereto. That is, the reward R may a point that can be exchanged with cash or other services, or various rewards.

### EXPLANATIONS OF LETTERS OR NUMERALS

1 CROP MANAGEMENT SYSTEM
2a BOOM (EXAMPLE OF MOVEMENT MEMBER)
2b CAMERA ARM (EXAMPLE OF ARM)
2c HARVESTING ARM (EXAMPLE OF ARM)
2d HARVESTING CHUCK
4 (104) CAMERA (EXAMPLE OF IMAGING UNIT)
6 (106) CONTROL DEVICE (EXAMPLE OF CONTROL UNIT)
8 (108) DISPLAY (DISPLAY UNIT)
21 SUPPORT COLUMN
22 RAIL
A CROP
101 ARTICLE SORTING SYSTEM
102 GRIP DEVICE
106a PROCESSING UNIT
106b STORAGE UNIT
1010 INPUT DEVICE
S SELECTION SCREEN

### DRAWINGS

FIG. 1
2 ROBOT
2a BOOM
2e FIRST ACTUATOR
2b CAMERA ARM
4 CAMERA
2f SECOND ACTUATOR
2c HARVESTING ARM
2g THIRD ACTUATOR
2d HARVESTING CHUCK
2h FOURTH ACTUATOR
6 CONTROL DEVICE
6b MEMORY
6c COMMUNICATION INTERFACE
6d IMAGE PROCESSING UNIT
6e MOTOR AND ACTUATOR CONTROL UNIT
8 DISPLAY UNIT
FIG. 4
S1 MOVE CAMERA
S2 ACQUIRE IMAGE DATA
S3 STORE IMAGE POSITION
S4 DETERMINE GROWING SITUATION
S5 IS THINNING NECESSARY?
S6 IS HARVEST NECESSARY?
S7 IS HARVEST ACCEPTANCE CONFIRMATION NECESSARY?
S8 DISPLAY HARVEST OR NON-HARVEST SCREEN
S9 IS HARVEST ACCEPTED?
S10 MOVE HARVESTING ARM
S11 STORE HARVEST POSITION
S12 CHANGE HARVEST PREDICTION
S13 IS THINNING ACCEPTANCE CONFIRMATION NECESSARY?
S14 DISPLAY THINNING OR NON-THINNING SCREEN
S15 IS THINNING ACCEPTED?
S16 MOVE THINNING DEVICE
S17 STORE THINNING POSITION
FIG. 7
SIZE
COLOR
SHAPE
THINNING
HARVEST
SIZE
COLOR
SHAPE
HARVEST
FIG. 8
SIZE
COLOR
SHAPE
FIG. 10
1012d FOURTH SORTING AREA
1012e FIFTH SORTING AREA
1012f SIXTH SORTING AREA
UP
LEFT
FRONT
DOWN
RIGHT
BACK
1012a FIRST SORTING AREA
1012b SECOND SORTING AREA
1012c THIRD SORTING AREA
106 CONTROL DEVICE
106a PROCESSING UNIT
106b STORAGE UNIT
FIG. 11
S201 ACQUIRE IMAGE DATA
S202 GENERATE ARTICLE REGION
S203 DESIGNATE ARTICLE CLASSIFICATION
S204 DOES ARTICLE CLASSIFICATION CORRESPOND TO FIRST
ARTICLE?
S205 GENERATE SELECTABLE REGION
S207 GENERATE SELECTION SCREEN
S208 TRANSMIT SELECTION SCREEN
S209 DISPLAY SELECTION SCREEN
S210 ACQUIRE WASTE X IN DESIGNATION
S211 ACQUIRE MATERIAL QUALITY OR MATERIAL Y
S212 GENERATE COMBINATION DATA Z
S213 STORE COMBINATION DATA Z
S214 GENERATE EVALUATION DATA r
S215 STORE EVALUATION DATA r
S216 CHANGE INTO SELECTED REGION xu
S217 IS SELECTABLE REGION xc NOT INCLUDED?
S218 DETERMINE REWARD R
S219 MOVE WASTE X TO SORTING AREA 10
S206 GENERATE SELECTED REGION
FIG. 13
S301 DETECT TOUCH POSITION
S302 DETERMINE TOUCHED POSITION AS ACQUISITION POSITION
S303 ACQUIRE COORDINATES ON SCREEN
S304 CONVERT COORDINATES ON SCREEN INTO ACTUAL ARRANGEMENT
POSITION
S305 TRANSMIT COORDINATES TO ARM

1. An article acquisition system, comprising:
an imaging unit configured to image an article;
an arm capable of acquiring the article;
a control unit configured to determine a shape of the article from image data captured by the imaging unit; and
a display unit capable of selecting whether or not to acquire the article,
wherein in a case where determination is made to acquire the article imaged by the imaging unit,
the control unit displays an arrangement position of the article on the display unit, and displays a screen to which an acquisition position of the article is input, and
in a case where the acquisition position is input, the control unit moves the arm toward the arrangement position, and moves the arm in conformity to the acquisition position to acquire the article.

2. The article acquisition system according to claim 1,
wherein the display unit is a touch panel type, and
the control unit acquires coordinates of the acquisition position input to the touch panel.

3. The article acquisition system according to claim 1,
wherein the control unit acquires coordinates of a position of the display unit which is traced by a user, and
the control unit moves the arm toward the coordinates.

4. The article acquisition system according to claim 1,
wherein the article corresponds to crops, and
the control unit moves the arm to harvest the crops in a case where the crop imaged by the imaging unit is selected as a harvest target or a thinning target.

5. The article acquisition system according to claim 4,
wherein the control unit records a position of the crops set as the harvest target or the thinning target, and
the control unit displays a position of at least one of the harvest target and the thinning target, and at least one of the crops set as the harvest target and the crops set as the thinning target on the display unit.

6. The article acquisition system according to claim 4,
wherein the control unit determines whether or not the crops are the harvest target or the thinning target by using at least one or both of a shape and a color of the crops imaged by the imaging unit, and
in a case where a management user of the crops is required to make a determination on the harvest target or the thinning target among the crops determined as the thinning target, the control unit displays at least one of the crops which become the harvest target and the thinning target on the display unit.

7. The article acquisition system according to claim 4,
wherein the control unit records harvest prediction data of the crops, and
the control unit updates the harvest prediction data in a case where the crops are thinned.

8. The article acquisition system according to claim 4, further comprising:
a plurality of support columns arranged in parallel with intervals in a house capable of accommodating the crops; and
at least one movement member hung on the plurality of support columns and is movable on an upper side of the crops inside the house,
wherein the arm is movable from the movement member toward the crops.

9. An article acquisition system,
wherein the control unit includes a processing unit configured to generate the selection screen that is image information obtained by synthesizing an article selection portion, which is a screen display corresponding to a first article among articles included in a video captured with the camera, to the video, and to determine a predetermined evaluation corresponding to an input of the combination on the basis of the combination input through the input device.

10. The article acquisition system according to claim 9,
wherein the control unit includes,
a storage unit configured to store the combination, and
the processing unit determines the evaluation on the basis of the combination stored in the storage unit among the articles included in the video.

11. The article acquisition system according to claim 9,
wherein the processing unit,
determines a reward on the basis of the number of input times of the combination to the input device, and the evaluation.

12. The article acquisition system according to claim 10,
wherein the storage unit stores the combination and the evaluation in association with each other.

13. The article acquisition system according to claim 10,
wherein the processing unit sorts a second article whose type is sortable among the articles on the basis of the combination stored in the storage unit, and sorts other articles excluding the second article as the first article.

14. The article acquisition system according to claim 10, further comprising:
a grip device configured to grip the articles,
wherein the control device controls the grip device on the basis of the combination input through the input device, and moves the articles to a predetermined position corresponding to the type.
